(19) United States
(12) Patent Application Publication
(10) Pub. No.: US 2025/0365395 A1
(43) Pub. Date: Nov. 27, 2025

(54) Laser Projection Device

(71) Applicant: Shenzhen Oceanwing Smart Innovations Technology Co., Ltd, Shenzhen (CN)

(72) Inventor: Yifeng Xie, Shenzhen (CN)

(21) Appl. No.: 19/213,335

(22) Filed: May 20, 2025

(30) Foreign Application Priority Data
May 22, 2024 (CN) 20241131015.7

(51) Int. Cl. H04N 9/31

(52) U.S. Cl. CPC H04N 9/3161; H04N 9/3114; H04N 9/3152

(57) ABSTRACT

Disclosed is a laser projection device which may include a laser light source configured to generate coherent light, a quantum mechanism configured to convert the coherent light into incoherent light and including a red, blue, and/or green quantum unit configured to receive the coherent light at different times, and/or a shaping mechanism configured to transmit the incoherent light from the red, blue, and/or green quantum unit in a same direction. Particle sizes of quantum dots included in the red, blue, and/or green quantum unit may be different. The red, blue, and/or green quantum unit may receive coherent light at different times and may convert it into incoherent light using quantum dots. This may avoid interference generated by the coherent light and may reduce speckles on the image formed by the laser projection device.

### CROSS-REFERENCE TO RELATED APPLICATION

The present application claims priority to Chinese Patent Application No. 202421131015.7, filed on May 22, 2024, which is herein incorporated by reference by its entirety.

### FIELD

The present disclosure relates to the technical field of laser projection. For example, aspects described herein may relate to a laser projection device.

### BACKGROUND

A laser projection device may perform projection with lasers of three primary colors of red, green and blue as a light source. Using three colors may reproduce rich and gorgeous colors of the objective world and provide more shocking expressive force. From the perspective of colorimetry, the color gamut coverage of a laser display may reach more than 90% of a color space that human eyes can recognize, which is more than twice the color gamut coverage of traditional display. This means that laser displays in some cases have a far wider gamut than traditional displays, allowing viewers to see a truer and more beautiful visual display. However, for many laser projection devices, speckles are prone to occur due to interference, and the presence of those speckles might ultimately affect an imaging effect of the laser projection device.

### SUMMARY

Aspects described herein relate to improving a speckle eliminating performance of a laser projection device. More particularly, aspects described herein may relate to a laser projection device including a laser light source configured to generate coherent light; a quantum mechanism configured to convert the coherent light into incoherent light and including a red quantum unit, a blue quantum unit and/or a green quantum unit configured to receive the coherent light at different times, in which particle sizes of quantum dots included in the red quantum unit, the blue quantum unit and the green quantum unit are different; and/or a shaping mechanism configured to transmit the incoherent light from the red quantum unit, the blue quantum unit and the green quantum unit in a same direction.

The laser projection device may include a reflecting mirror which may receive the coherent light and may be capable of rotating. The quantum mechanism may be fixed. When the reflecting mirror rotates, the reflecting mirror may transmit the coherent light to the red quantum unit, the blue quantum unit and/or the green quantum unit (e.g., at different times and/or separately).

During rotation, the reflecting mirror may be a plane mirror and may be disposed at an acute angle with the coherent light. The reflecting mirror may reflect the coherent light at a first position to form a first light ray, at a second position to form a second light ray, and/or at a third position to form a third light ray. The first light ray may be perpendicular to the coherent light, the second light ray and the third light ray may be located at opposite sides of the first light ray respectively, and included angles of the second light ray and the third light ray with the first light ray may be equal.

In some examples, the green quantum unit may receive the first light ray, one of the blue quantum unit and the red quantum unit may receive the second light ray and the other of the blue quantum unit and the red quantum unit may receive the third light ray.

The red quantum unit, the blue quantum unit and/or the green quantum unit may be arranged along a straight line parallel to the coherent light between the reflecting mirror and the laser light source. In such an example, the green quantum unit may be located between the red quantum unit and the blue quantum unit.

The reflecting mirror may be a plane mirror, and at a first position, the reflecting mirror may be perpendicular to the coherent light and transmits the coherent light to form a first light ray; at a second position, the reflecting mirror may be at an acute angle with the coherent light and reflects the coherent light to form a second light ray; and at a third position, the reflecting mirror may be at an acute angle with the coherent light and reflects the coherent light to form a third light ray. In that example, the reflecting mirror at the second position may be perpendicular to the reflecting mirror at the third position, transmission directions of the first light ray and the coherent light may be the same, and transmission directions of the second light ray and the third light ray may be opposite and perpendicular to the coherent light between the reflecting mirror and the laser light source.

The green quantum unit may be perpendicular to the coherent light and may receive the first light ray. The red quantum unit and the blue quantum unit may be located at opposite sides of the coherent light. One of the red quantum unit and the blue quantum unit may receive the second light ray, and the other of the red quantum unit and the blue quantum unit may receive the third light ray.

The laser projection device may further comprise a first reflector, a second reflector, a third reflector, and/or a fourth reflector. The first reflector and the fourth reflector may be parallel to the reflecting mirror at the second position, and the second reflector and the third reflector may be parallel to the reflecting mirror at the third position. In this example, the second light ray passing through the quantum mechanism may be reflected by the first reflector and the second reflector in turn to form a light ray parallel to and having the same transmission direction with the third light ray, and the third light ray passing through the quantum mechanism may be reflected by the third reflector and the fourth reflector in turn to form a light ray parallel to and having the same transmission direction with the second light ray.

The quantum mechanism may be capable of moving in a straight line perpendicular to the coherent light, and the red quantum unit, the blue quantum unit, and/or the green quantum unit may be arranged in a straight line perpendicular to the coherent light. In such an example, when the quantum mechanism moves, the coherent light may be transmitted to the red quantum unit, the blue quantum unit, and/or the green quantum unit at different times.

The laser projection device may further comprise an elastic member, one end of which may be fixedly connected, and the other end of which may be connected with the quantum mechanism.

A variety of conditions may be met by the arrangements described herein. One condition that may be met is that the red quantum unit, the blue quantum unit and the green quantum unit may be integrally connected or spliced with each other when arranged along a straight line. Another condition that may be met is that the red quantum unit, the blue quantum unit, and the green quantum unit may each further comprise a housing, and the quantum dots are uniformly distributed within that housing. Another condition that may be met is that particle sizes of the quantum dots in the red quantum unit may range from 2.5 nm to 3.5 nm, particle sizes of the quantum dots in the green quantum unit may range from 1 nm to 2 nm, and particle sizes of the quantum dots in the blue quantum unit may range from 0.5 nm to 1.5 nm. Another condition that may be met is that the laser projection device may further comprise an imaging element configured to receive a light ray from the shaping mechanism for imaging. Another condition that may be met is that the coherent light may be blue laser or ultraviolet laser. Another condition that may be met is that the incoherent lights passing through the red quantum unit, the blue quantum unit, and/or the green quantum unit may be parallel to each other or located in a same straight line after passing through the shaping mechanism.

One of the many technical effects of an example of the disclosure is that the red quantum unit, the blue quantum unit, and/or the green quantum unit may receive the coherent light at different times and/or may convert the coherent light into incoherent light under the action of the quantum dots. Either or both approaches may effectively avoid interference generated by the coherent light, thereby reducing speckles occurring on the image formed by the laser projection device. In turn, this may improve the speckle eliminating performance of the laser projection device.

### BRIEF DESCRIPTION OF THE DRAWINGS

FIG. 1 is a planar structure diagram of a laser projection device.

FIG. 2 is a planar structure diagram of a laser projection device.

FIG. 3 is a planar structure diagram of a laser projection device.

The figures may refer to various reference numerals, including those defined here for ease of reading: laser projection device 10, laser light source 100, coherent light 110, quantum mechanism 200, red quantum unit 210, blue quantum unit 220, green quantum unit 230, housing 241, quantum dot 242, shaping mechanism 300, reflecting mirror 400, first position 410, second position 420, third position 430, first light ray 401, second light ray 402, third light ray 403, first reflector 510, second reflector 520, third reflector 530, fourth reflector 540, elastic member 600, imaging element 700.

### DETAILED DESCRIPTION

Specific examples of the present disclosure will be described in detail with reference to the drawings. Numerous specific details are set forth in the following description to thoroughly understand the present disclosure. However, the present disclosure may be implemented in many other ways different from those described herein, similar improvements can be made by those skilled in the art without departing from the spirit of the present disclosure, and thus the present disclosure is not limited by specific examples to be disclosed below.

In description of the disclosure, orientation or position relationships indicated by the terms “center,” “longitudinal,” “transverse,” “length,” “width,” “thickness,” “upper,” “lower,” “front,” “rear,” “left,” “right,” “vertical,” “horizontal,” “top,” “bottom,” “inside,” “outside,” “clockwise,” “counterclockwise,” “axial,” “radial,” “circumferential,” and the like are included for illustrative purposes and do not indicate or imply that the referred device or element must have a specific orientation and be constructed and operated in a specific orientation. In turn, these terms do not limit the disclosure herein.

In addition, the terms “first,” “second,” and “third” herein are used for illustrative purposes only and are not to be construed as indicating or implying the relative importance or implicitly indicating the number of indicated technical features. Thus, features defined with “first” and “second” may explicitly or implicitly include at least one of such features. In the description of the present disclosure, “a plurality of” means at least two, for example, two, three, and so on, unless otherwise explicitly and specifically defined herein.

In the present disclosure, terms such as “mount,” “communicate,” “connect,” and “fix” are intended in their broadest meaning. For example, the terms may refer to fixed connection, detachable connection, or integration; may refer to mechanical connection or electrical connection; may refer to direct connection, indirect connection via an intermediary, or internal communication or interaction relationship between two elements, unless expressly defined.

In the present disclosure, if a first feature may be described as “above” or “below” a second feature, it may mean that the first and second features are in direct contact or in indirect contact through an intermediary. Furthermore, the first feature being “above,” “upon,” and/or “on” the second feature may mean that the first feature is directly above or obliquely above the second feature, or might simply mean that the first feature may be higher than the second feature in the horizontal height. Furthermore, the first feature being “below,” “beneath,” and/or “under” the second feature may mean that the first feature is directly below or obliquely below the second feature, or simply mean that the first feature may be lower than the second feature in the horizontal height.

It should be noted that if an element may be referred to as “fixed to” or “disposed on” another element, it may be directly on the other element or a middle element may be present. If an element may be considered to be “connected” to another element, it may be directly connected to the other element or a middle and/or intermediary element may be present. The terms “vertical,” “horizontal,” “upper,” “lower,” “left,” “right,” and similar expressions used herein are for the purpose of description only and are not intended to be the only examples.

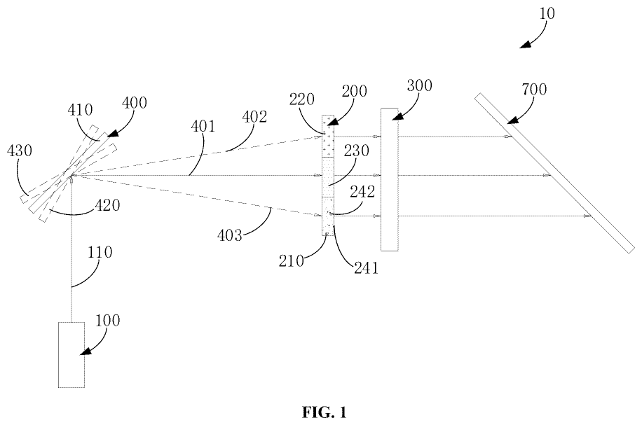

Referring to FIG. 1, a laser projection device 10 provided in an example of the present disclosure may include a laser light source 100, a quantum mechanism 200, and a shaping mechanism 300. The laser light source 100 may be configured to generate coherent light 110, the quantum mechanism 200 may be configured to convert the coherent light 110 into incoherent light, and/or the shaping mechanism 300 may be configured to integrate the incoherent light from the quantum mechanism 200, so that the shaping mechanism 300 may transmit the incoherent light in a same or similar direction. The incoherent light from the shaping mechanism 300 may be received by an imaging element 700 for image display. Since light passing through the quantum mechanism 200 may be the incoherent light, interference generated by the coherent light 110 might be effectively avoided, thereby reducing speckles occurring on the imaging element 700 and improving speckle eliminating performance of the laser projection device 10.

The laser light source 100 may generate the coherent light 110, which may be a blue laser and/or an ultraviolet laser. The quantum mechanism 200 may include a red quantum unit 210, a blue quantum unit 220, and/or a green quantum unit 230. The red quantum unit 210, the blue quantum unit 220, and/or the green quantum unit 230 may all be substantially flat in shape. For example, the red quantum unit 210, the blue quantum unit 220, and/or the green quantum unit 230 may be arranged along a straight line, so that the red quantum unit 210, the blue quantum unit 220, and/or the green quantum unit 230 may be spliced or integrally connected with each other. As another example, the red quantum unit 210, the blue quantum unit 220, and/or the green quantum unit 230 might not be arranged along a straight line, and are may be discrete and/or located in different positions.

The red quantum unit 210, the blue quantum unit 220, and/or the green quantum unit 230 each may include a housing 241 and/or granular quantum dots 242. The quantum dots 242 may be uniformly distributed within the housing 241, so that the housing 241 might house the quantum dots 242. The housing 241 may be made of glass and may have a high temperature resistance. Particle sizes of the quantum dots 242 in the red quantum unit 210, the blue quantum unit 220, and/or the green quantum unit 230 may be different, and the particle sizes might be the same or similar to the diameters of the quantum dots 242. Particle sizes of quantum dots 242 in the red quantum unit 210 may range from 2.5 nm to 3.5 nm (and, for instance, might be 3 nm). Under the action of the quantum dots 242, the coherent light 110 passing through the red quantum unit 210 may be converted into red incoherent light with a full width at half maximum of less than 30 nm. Particle sizes of quantum dots 242 in the green quantum unit 230 may range from 1.5 nm 2 nm (e.g., the particle sizes may be 1.5 nm). Under the action of the quantum dots 242, the coherent light 110 passing through the green quantum unit 230 may be converted into green incoherent light with a full width at half maximum of less than 30 nm. Particle sizes of quantum dots 242 in the blue quantum unit 220 range from 1.5 nm 2 nm (e.g., the particle sizes may be 1 nm). Under the action of the quantum dots 242, the coherent light 110 passing through the blue quantum unit 220 may be converted into blue incoherent light with a full width at half maximum of less than 30 nm. Due to the small full width at half maximum, a color gamut of the incoherent light might be reasonably improved, thereby improving clarity and fidelity of an image of the laser projection device 10.

The laser projection device 10 may further comprise a reflecting mirror 400, which may be a flat plane mirror and might be capable of rotating around a fixed axis. The red quantum unit 210, the blue quantum unit 220, and/or the green quantum unit 230 may be fixed. When the reflecting mirror 400 rotates to different positions, the reflecting mirror 400 may transmit the coherent light 110 to the red quantum unit 210, the blue quantum unit 220, and/or the green quantum unit 230 at different times. Rotation of the reflecting mirror 400 might be realized by a stepper motor, so that rotation accuracy of the reflecting mirror 400 can be improved.

During rotation, the reflecting mirror 400 may be disposed at an acute angle with the coherent light 110, and the reflecting mirror 400 may be at a first position 410, a second position 420, and/or a third position 430. When the reflecting mirror 400 is located at the first position 410, the coherent light 110 may be reflected by the reflecting mirror 400 to form a first light ray 401, and the first light ray 401 may be perpendicular to the coherent light 110, in which case an incident angle of the coherent light 110 may be 45°. When the reflecting mirror 400 is located at the second position 420, the coherent light 110 may be reflected by the reflecting mirror 400 to form a second light ray 402, in which case an incident angle of the coherent light 110 may be greater than 45°. When the reflecting mirror 400 is located at the third position 430, the coherent light 110 may be reflected by the reflecting mirror 400 to form a third light ray 403, in which case an incident angle of the coherent light 110 may be less than 45°. The second light ray 402 and the third light ray 403 may be located at opposite sides of the first light ray 401, and included angles formed by the second light ray 402 and the third light ray 403 with the first light ray 401 might be equal and/or substantially equal. The included angles may be acute angles. When the reflecting mirror 400 rotates, the reflecting mirror 400 may first rotate from the third position 430 to the first position 410, and then from the first position 410 to the second position 420; that is, the reflecting mirror 400 might be configured to rotate counterclockwise. Additionally and/or alternatively, the reflecting mirror 400 may first rotate from the second position 420 to the first position 410, and then rotate from the first position 410 to the third position 430; that is, the reflecting mirror 400 might be configured to rotate clockwise.

The red quantum unit 210, the blue quantum unit 220, and/or the green quantum unit 230 may be arranged along a straight line parallel to the coherent light 110, and/or the green quantum unit 230 may be located between the red quantum unit 210 and/or the blue quantum unit 220. In such an example, the green quantum unit 230 may be disposed in the middle. The red quantum unit 210 and/or the blue quantum unit 220 might also be disposed in the middle. The green quantum unit 230 may receive the first light ray 401, which can be converted into green incoherent light after passing through the green quantum unit 230. One of the blue quantum unit 220 and the red quantum unit 210 may receive the second light ray 402, and the other of the blue quantum unit 220 and the red quantum unit 210 may receive the third light ray 403. For example, the blue quantum unit 220 may receive the second light ray 402, which may be converted into blue incoherent light after passing through the blue quantum unit 220; and the red quantum unit 210 may receive the third light ray 403, which may be converted into red incoherent light after passing through the red quantum unit 210. Additionally and/or alternatively, the red quantum unit 210 may receive the second light ray 402, and the blue quantum unit 220 may receive the third light ray 403.

The shaping mechanism 300 can be a special optical element. When light rays from the red quantum unit 210, the blue quantum unit 220 and/or the green quantum unit 230 reach the shaping mechanism 300, the shaping mechanism 300 may adjust propagation directions of the red, blue and green incoherent lights, so that the incoherent lights of the three colors may be parallel to each other and have a same transmission direction, and thus the incoherent lights of the three colors may reach the imaging element 700 as parallel light for image display.

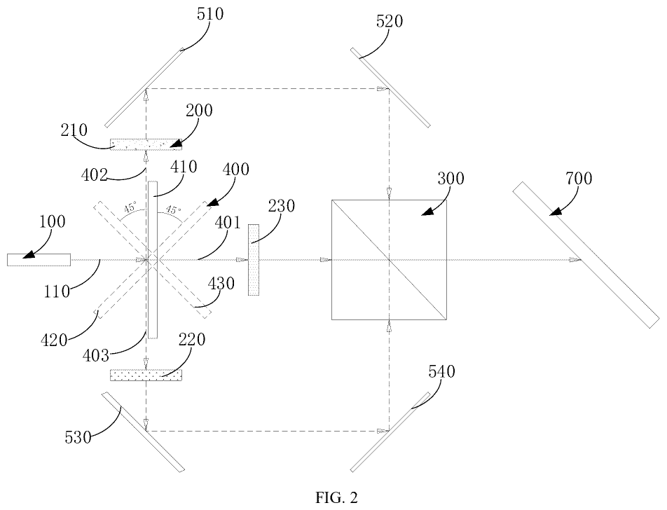

Referring to FIG. 2, during the rotation, the reflecting mirror 400 may be disposed at an acute angle with the coherent light 110 and/or perpendicular to the coherent light 110. The reflecting mirror 400 may also be at the first position 410, the second position 420, and/or the third position 430. At the first position 410, the reflecting mirror 400 may be perpendicular to the coherent light 110. in which case an incident angle of the coherent light 110 may be 0°, so that the coherent light 110 can pass through the reflecting mirror 400 in an original direction to form the first light ray 401, that is, the reflecting mirror 400 might transmit the coherent light 110. At the second position 420, the reflecting mirror 400 may be at an acute angle with the coherent light 110, in which case an incident angle of the coherent light 110 may be 45°, so that the coherent light 110 may be reflected by the reflecting mirror 400 to form a second light ray 402, and the second light ray 402 may be perpendicular to the coherent light 110. At the third position 430, the reflecting mirror 400 may be at an acute angle with the coherent light 110, in which case an incident angle of the coherent light 110 may be 45°, so that the coherent light 110 may be reflected by the reflecting mirror 400 to form a third light ray 403, and the third light ray 403 may be perpendicular to the coherent light 110. Transmission directions of the second light ray 402 and/or the third light ray 403 are opposite to each other and/or located in a same straight line, the first light ray 401 and the coherent light 110 may have a same transmission direction and located in a same straight line, the second light ray 402 and the third light ray 403 may be respectively located at opposite sides of the coherent light 110, and the reflecting mirror 400 at the second position 420 and the reflecting mirror 400 at the first position 410 may be perpendicular to each other. When the reflecting mirror 400 rotates, the reflecting mirror 400 might first rotate from the third position 430 to the first position 410, and then from the first position 410 to the second position 420, that is, the reflecting mirror 400 might rotate clockwise. Additionally and/or alternatively, the reflecting mirror 400 may first rotate from the second position 420 to the first position 410, and then rotate from the first position 410 to the third position 430, that is, the reflecting mirror 400 might rotate counterclockwise.

The green quantum unit 230 may be perpendicular to the coherent light 110, and the green quantum unit 230 may receive the first light ray 401, which can be converted into green incoherent light after passing through the green quantum unit 230. The red quantum unit 210 may be parallel to the coherent light 110, and the red quantum unit 210 may receive the second light ray 402, which can be converted into red incoherent light after passing through the red quantum unit 210. The blue quantum unit 220 may be parallel to the coherent light 110, and the blue quantum unit 220 may receive the third light ray 403, which can be converted into blue incoherent light after passing through the blue quantum unit 220. The blue quantum unit 220 and/or the red quantum unit 210 may be located at opposite sides of the coherent light 110. Of course, the red quantum unit 210 may receive any one of the first light ray 401, the second light ray 402, and/or the third light ray 403, the green quantum unit 230 may receive any one of the first light ray 401, the second light ray 402, and/or the third light ray 403, and the blue quantum unit 220 may receive any one of the first light ray 401, the second light ray 402, and/or the third light ray 403.

The laser projection device 10 may additionally and/or alternatively comprise a first reflector 510, a second reflector 520, a third reflector 530, and/or a fourth reflector 540. The first reflector 510 and the second reflector 520 may be located at one side of the coherent light 110, and the first reflector 510 and the second reflector 520 may be arranged at an interval along a transmission direction of the coherent light 110. The third reflector 530 and the fourth reflector 540 may be located at the other side of the coherent light 110, and the third reflector 530 and the fourth reflector 540 may be arranged at an interval along the transmission direction of the coherent light 110. The first reflector 510 and the fourth reflector 540 may be parallel to the reflecting mirror 400 at the second position 420, and the second reflector 520 and the third reflector 530 may be parallel to the reflecting mirror 400 at the third position 430. The red incoherent light generated by the second light ray 402 passing through the red quantum unit 210 travels along a transmission direction of the second light ray 402. The red incoherent light may be first reflected by the first reflector 510 at an incident angle of 45°, and the red incoherent light reflected by the first reflector 510 may be parallel to the coherent light 110 and has a same transmission direction as the coherent light 110. The red incoherent light reflected by the first reflector 510 may be reflected again by the second reflector 520 at an incident angle of 45°, so that the red incoherent light reflected by the second reflector 520 may be parallel to the third light ray 403 and has a same transmission direction as the third light ray. The blue incoherent light generated by the third light ray 403 passing through the blue quantum unit 220 may travel along a transmission direction of the third light ray 403. The blue incoherent light reflected by the third reflector 530 at an incident angle of 45° may be parallel to the coherent light 110 and has a same transmission direction as the coherent light 110. The blue incoherent light reflected by the third reflector 530 may be reflected again by the fourth reflector 540 at an incident angle of 45°, so that the red incoherent light reflected by the fourth reflector 540 may be parallel to the second light ray 402 and may have a same transmission direction as the second light ray. The green incoherent light generated by the green quantum unit 230 and the coherent light 110 may be in a same straight line and have a same transmission direction.

The shaping mechanism 300 may be a special prism combining element, and with reflection of light rays by the first reflector 510, the second reflector 520, the third reflector 530, and/or the fourth reflector 540, light rays from the red quantum unit 210, the blue quantum unit 220, and/or the green quantum unit 230 may reach the shaping mechanism 300 (e.g., in different directions). The shaping mechanism 300 may adjust propagation directions of the red, blue and green incoherent light, so that the incoherent lights of the three colors might be located in the same straight line and may have a same transmission direction. In this example, the incoherent lights of the three colors may arrive at the imaging element 700 along the same straight line for image display.

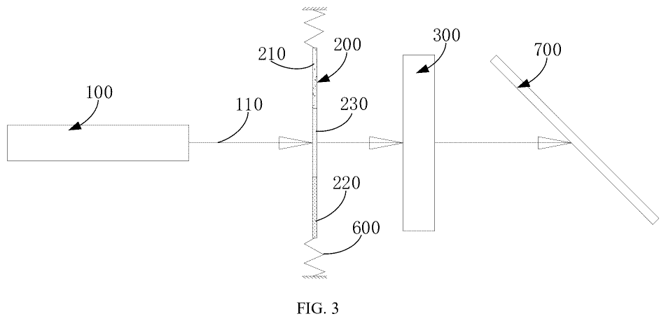

Referring to FIG. 3, the quantum mechanism 200 may move in a straight line perpendicular to the coherent light 110, the red quantum unit 210, the blue quantum unit 220, and/or the green quantum unit 230 may be arranged in a straight line perpendicular to the coherent light 110, and the green quantum unit 230 may be centrally disposed. When the quantum mechanism 200 moves in a straight line, the coherent light 110 may be transmitted to the red quantum unit 210, the blue quantum unit 220, and/or the green quantum unit 230 at different times. For example, when the whole quantum mechanism 200 is located at an upper side of the coherent light 110, the quantum mechanism 200 might be moved downward. During downward movement of the quantum mechanism 200, the coherent light 110 may first pass through the blue quantum unit 220, then through the green quantum unit 230, and finally through the red quantum unit 210. As another example, when the whole quantum mechanism 200 is located at a lower side of the coherent light 110, the quantum mechanism 200 might be moved upward. During upward movement of the quantum mechanism 200, the coherent light 110 might first pass through the red quantum unit 210, then through the green quantum unit 230, and finally through the blue quantum unit 220.

The shaping mechanism 300 might be a special optical element. When light rays from the red quantum unit 210, the blue quantum unit 220, and/or the green quantum unit 230 reach the shaping mechanism 300 (e.g., separately), the shaping mechanism 300 may adjust propagation directions of the red, blue, and/or green incoherent light, so that the incoherent lights of the three colors may be located in a same straight line and/or might have a same propagation direction. This may ensure that the incoherent lights of the three colors reach the imaging element 700 along the same straight line for image display.

The laser projection device 10 may further include an elastic member 600, one end of which may be fixedly connected, and the other end of which may be connected with the quantum mechanism 200. There may be two elastic members 600 which are located at two ends of the quantum mechanism 200 respectively, and the elastic member 600 may be a spring or the like. By providing the elastic member 600, movement of the quantum mechanism 200 can be buffered and/or a restoring force might be generated on the quantum mechanism 200 to play a restoring role.

The laser projection device 10 may further include an imaging element 700. When the incoherent light from the shaping mechanism 300 reaches the imaging element 700, the light might be imaged to display an image. The red quantum unit 210, the blue quantum unit 220, and/or the green quantum unit 230 may receive the coherent light at different times and/or may convert the coherent light 110 into incoherent light under the action of the quantum dots 242, which might avoid interference generated by the coherent light 110 on the imaging element 700, thereby reducing speckles occurring on the imaging element 700, and improving speckle eliminating performance of the laser projection device 10.

The technical features of the above-mentioned examples can be combined as desired. Not all possible combinations of the technical features in the above examples are described. A wide variety of combinations should be considered as falling within the scope of the specification.

The examples described above represent only a few examples of the present disclosure. Several variations and improvements might be made without departing from the spirit of the disclosure for those skilled in the art, all of which fall within the scope of the present disclosure.

What is claimed is:

1. A laser projection device comprising:
a laser light source configured to generate coherent light;
a quantum mechanism configured to convert the coherent light into incoherent light and comprising:
a red quantum unit,
a blue quantum unit, and
a green quantum unit, wherein each of the red quantum unit, the blue quantum unit, and the green quantum unit are configured to receive the coherent light at different times, and wherein particle sizes of quantum dots included in the red quantum unit, the blue quantum unit and the green quantum unit are different; and
a shaping mechanism configured to transmit the incoherent light from the red quantum unit, the blue quantum unit and the green quantum unit in a same direction.

2. The laser projection device according to claim 1, further comprising:
a reflecting mirror configured to receive the coherent light, wherein the reflecting mirror is capable of rotating, wherein the quantum mechanism is fixed, and wherein, when the reflecting mirror rotates, the reflecting mirror is configured to transmit the coherent light to the red quantum unit, the blue quantum unit and the green quantum unit at different times.

3. The laser projection device according to claim 1, further comprising:
a reflecting mirror configured to rotate and configured to transmit the coherent light to the red quantum unit, the blue quantum unit and the green quantum unit at different times, wherein the reflecting mirror is at an acute angle with the coherent light, wherein the reflecting mirror reflects the coherent light at a first position to form a first light ray, at a second position to form a second light ray, and at a third position to form a third light ray, wherein the first light ray is perpendicular to the coherent light, wherein the second light ray and the third light ray are located at opposite sides of the first light ray, and wherein angles of the second light ray and the third light ray as compared to the first light ray are equal.

4. The laser projection device according to claim 1, wherein the green quantum unit is configured to receive a first light ray of the coherent light, wherein one of the blue quantum unit or the red quantum unit is configured to receive a second light ray of the coherent light, and wherein the other of the blue quantum unit or the red quantum unit is configured to receive a third light ray of the coherent light.

5. The laser projection device according to claim 1, wherein the red quantum unit, the blue quantum unit, and the green quantum unit are arranged along a straight line parallel to the coherent light between a reflecting mirror and the laser light source, and wherein the green quantum unit is located between the red quantum unit and the blue quantum unit.

6. The laser projection device according to claim 1, further comprising:
a reflecting mirror, wherein:
at a first position, the reflecting mirror is perpendicular to the coherent light and transmits the coherent light to form a first light ray;
at a second position, the reflecting mirror is at an acute angle with the coherent light and reflects the coherent light to form a second light ray; and
at a third position, the reflecting mirror is at an acute angle with the coherent light and reflects the coherent light to form a third light ray, wherein the reflecting mirror at the second position is perpendicular to the reflecting mirror at the third position, wherein transmission directions of the first light ray and the coherent light are same, and wherein transmission directions of the second light ray and the third light ray are opposite and perpendicular to the coherent light between the reflecting mirror and the laser light source.

7. The laser projection device according to claim 1, wherein the green quantum unit is perpendicular to the coherent light and is configured to receive a first light ray of the coherent light, wherein the red quantum unit and the blue quantum unit are located at opposite sides of the coherent light, wherein one of the red quantum unit and the blue quantum unit are configured to receive a second light ray of the coherent light, and wherein the other of the red quantum unit and the blue quantum unit is configured to receive a third light ray of the coherent light.

8. The laser projection device according to claim 1, further comprising:
a first reflector,
a second reflector,
a third reflector, and
a fourth reflector, wherein the first reflector and the fourth reflector are parallel to a reflecting mirror at a first position,
wherein the second reflector and the third reflector are parallel to the reflecting mirror at a second position,
wherein a first light ray passing through the quantum mechanism is reflected by the first reflector and the second reflector to form a light ray parallel to and having the same transmission direction with a second light ray,
wherein the second light ray passing through the quantum mechanism is reflected by the third reflector and the fourth reflector in turn to form a light ray parallel to and having the same transmission direction with the first light ray.

9. The laser projection device according to claim 1, wherein the quantum mechanism is capable of moving in a straight line perpendicular to the coherent light, wherein the red quantum unit, the blue quantum unit, and the green quantum unit are arranged in a straight line perpendicular to the coherent light, and wherein, when the quantum mechanism moves, the coherent light is transmitted to the red quantum unit, the blue quantum unit, and the green quantum unit at different times.

10. The laser projection device according to claim 1, further comprising:
an elastic member, one end of which is fixedly connected, and the other end of which is connected with the quantum mechanism.

11. The laser projection device according to claim 1, wherein at least one of the following is satisfied:
the red quantum unit, the blue quantum unit, and the green quantum unit are integrally connected or spliced with each other when arranged along a straight line;
the red quantum unit, the blue quantum unit, and the green quantum unit each further comprise a housing, and wherein the quantum dots are uniformly distributed within the housing;
particle sizes of the quantum dots in the red quantum unit range from 2.5 nm to 3.5 nm, particle sizes of the quantum dots in the green quantum unit range from 1 nm to 2 nm, and particle sizes of the quantum dots in the blue quantum unit range from 0.5 nm to 1.5 nm;
the laser projection device further comprises an imaging element configured to receive a light ray from the shaping mechanism for imaging;
the coherent light is blue laser or ultraviolet laser; and
the incoherent lights passing through the red quantum unit, the blue quantum unit, and the green quantum unit are parallel to each other or located in a same straight line after passing through the shaping mechanism.

12. A laser projection device comprising:
a reflecting mirror configured to receive coherent light from a laser light source and transmit the coherent light to a red quantum unit, a blue quantum unit and a green quantum unit at different times;
a quantum mechanism configured to convert the coherent light into incoherent light and comprising:
the red quantum unit,
the blue quantum unit, and
the green quantum unit, wherein particle sizes of quantum dots included in the red quantum unit, the blue quantum unit and the green quantum unit are different; and
a shaping mechanism configured to transmit the incoherent light from the quantum mechanism in a same direction.

13. The laser projection device according to claim 12, further comprising:
wherein the reflecting mirror is at an acute angle with the coherent light, wherein the reflecting mirror reflects the coherent light at a first position to form a first light ray, at a second position to form a second light ray, and at a third position to form a third light ray, wherein the first light ray is perpendicular to the coherent light, wherein the second light ray and the third light ray are located at opposite sides of the first light ray, and wherein angles of the second light ray and the third light ray as compared to the first light ray are equal.

14. The laser projection device according to claim 12, wherein the green quantum unit is configured to receive a first light ray of the coherent light, wherein one of the blue quantum unit or the red quantum unit is configured to receive a second light ray of the coherent light, and wherein the other of the blue quantum unit or the red quantum unit is configured to receive a third light ray of the coherent light.

15. The laser projection device according to claim 12, wherein the red quantum unit, the blue quantum unit, and the green quantum unit are arranged along a straight line parallel to the coherent light between the reflecting mirror and the laser light source, and wherein the green quantum unit is located between the red quantum unit and the blue quantum unit.

16. The laser projection device according to claim 12, wherein:
at a first position, the reflecting mirror is perpendicular to the coherent light and transmits the coherent light to form a first light ray;
at a second position, the reflecting mirror is at an acute angle with the coherent light and reflects the coherent light to form a second light ray; and
at a third position, the reflecting mirror is at an acute angle with the coherent light and reflects the coherent light to form a third light ray, wherein the reflecting mirror at the second position is perpendicular to the reflecting mirror at the third position, wherein transmission directions of the first light ray and the coherent light are same, and wherein transmission directions of the second light ray and the third light ray are opposite and perpendicular to the coherent light between the reflecting mirror and the laser light source.

17. A method comprising:
receiving, from a laser light source, coherent light;
converting, using a quantum mechanism comprising a red quantum unit, a blue quantum unit, and a green quantum unit, the coherent light into incoherent light, wherein each of the red quantum unit, the blue quantum unit, and the green quantum unit are configured to receive the coherent light at different times, and wherein particle sizes of quantum dots included in the red quantum unit, the blue quantum unit and the green quantum unit are different; and
transmitting, using a shaping mechanism, the incoherent light from the red quantum unit, the blue quantum unit and the green quantum unit in a same direction.

18. The method of claim 17, further comprising:
transmitting the coherent light to the red quantum unit, the blue quantum unit, and the green quantum unit by reflecting, using a reflecting mirror, the coherent light.

19. The method of claim 17, further comprising:
reflecting, using a reflecting mirror, the coherent light to the red quantum unit, the blue quantum unit, and the green quantum unit, wherein the reflecting mirror reflects the coherent light at a first position to form a first light ray, at a second position to form a second light ray, and at a third position to form a third light ray, wherein the first light ray is perpendicular to the coherent light, wherein the second light ray and the third light ray are located at opposite sides of the first light ray, and wherein angles of the second light ray and the third light ray as compared to the first light ray are equal.

20. The method of claim 17, wherein each of the red quantum unit, the blue quantum unit, and the green quantum unit are configured to receive different light rays of the coherent light.
